(19) United States
(12) Patent Application Publication
(10) Pub. No.: US 2011/0222156 A1
(43) Pub. Date: Sep. 15, 2011

(54) Diffractive Element for Optical Pickup and Optical Module Including the Same

(75) Inventors: Byeong Moo Jeong, Gyeonggi-do (KR); Kyung Ho Jung, Gyeonggi-do (KR)

(73) Assignee: LMS CO., LTD, Gunpo-si (KR)

(21) Appl. No.: 12/755,750

(22) Filed: Apr. 7, 2010

(30) Foreign Application Priority Data
Mar. 11, 2010 (KR) 10-2010-0021634

(51) Int. Cl. G02B 5/18

(52) U.S. Cl. 359/575

(57) ABSTRACT

Provided are a diffractive element for optical pickup and an optical module including the diffractive element. The diffractive element includes a plurality of diffraction patterns, and the diffraction patterns include a main diffraction pattern for creating diffraction characteristics, and an alignment mark pattern for recognizing an alignment position, the alignment mark pattern having a different pitch from the main diffraction pattern. Also, the pitch of the alignment mark pattern is formed smaller than that of the main diffraction pattern. Further, a ratio of the pitch of the alignment mark pattern to that of the main diffraction pattern is ⅛ or greater to ½ or less.

### CROSS-REFERENCE TO RELATED APPLICATION

This application claims priority to and the benefit of Korean Patent Application No. 2010-0021634, filed Mar. 11, 2010, the disclosure of which is incorporated herein by reference in its entirety.

### BACKGROUND

1. Field of the Invention

The present invention relates to a diffractive element for optical pickup, and an optical module including the diffractive element.

2. Discussion of Related Art

In general, an optical pickup device including a diffractive element or phase element detecting data by detecting an optical signal may be used in a CD, DVD or Blue Ray Disk (BD) player reading data recorded on an optical disk such as a CD, DVD or BD to read information from an optical recording medium.

Briefly examining the optical pickup device, it may include a laser diode irradiating a laser beam, a diffractive element distributing light intensity of the laser beam irradiated from the laser diode at a predetermined ratio, a beam splitter transmitting or reflecting a reflected beam and an incident beam through the diffractive element according to data recorded on an optical disk at a predetermined ratio, and a photodetector receiving the beam and detecting data.

The diffractive element in the optical pickup device may have diffraction patterns produced by a plurality of grooves formed on a substrate, and may function to divide the laser beam irradiated from the laser diode into a main beam and two sub-beams to move towards the optical disk.

The diffractive element installed in the CD or DVD player may be formed to an extremely small size. Actually, it may be implemented as small as 1.5 mm×1.5 mm, and installing the diffractive element may require special attention during a process of fabricating an optical pickup device. In particular, considering an intended location and direction due to optical properties of the diffractive element, i.e., that a diffraction direction of light should be implemented as intended, the diffractive element should be exactly mounted and installed. However, the small size of the diffractive element may be an obstacle to the installation. In particular, such defective mounting and installation may cause malfunction of the optical pickup device such as a CD or DVD player.

### SUMMARY OF THE INVENTION

The present invention is directed to a diffractive element in which a mark pattern for confirming alignment is formed to facilitate exact installation of the diffractive element and an optical module including the same.

One aspect of the present invention provides a diffractive element including a plurality of diffraction patterns, and the diffraction patterns include a main diffraction pattern for creating diffraction characteristics, and an alignment mark pattern for recognizing an alignment position, the alignment mark pattern having a different pitch from the main diffraction pattern.

The pitch of the alignment mark pattern may be formed smaller than that of the main diffraction pattern.

A ratio of the pitch of the alignment mark pattern to that of the main diffraction pattern may be ⅛ or greater to ½ or less.

The pitch of the main diffraction pattern may be about 5 μm or greater to about 30 μm or less, and the pitch of the alignment mark pattern may be about 1 μm or greater to about 6 μm or less.

The diffractive element may have a quadrilateral shape in a plan view thereof, and the alignment mark pattern may be formed at a corner of the quadrilateral.

The depth of the main diffraction pattern may be different from that of the alignment mark pattern.

The depth of the alignment mark pattern may be about 0.1 μm or greater to about 0.7 μm or less.

The alignment mark pattern may be formed of a plurality of patterns having different shapes.

Another aspect of the present invention provides an optical module including a polarizing filter or a wave plate on a top or bottom surface of the diffractive element.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates the configuration of an optical pickup device to which a diffractive element is applied according to an exemplary embodiment of the present invention;

FIG. 2 is a perspective view of a diffractive element according to a first exemplary embodiment of the present invention;

FIG. 3 is a plan view of the diffractive element according to a first exemplary embodiment of the present invention;

FIG. 4 is a plan view of a diffractive element according to a second exemplary embodiment of the present invention; and

FIG. 5 illustrates a picture of an actually implemented diffractive element according to an exemplary embodiment of the present invention.

### DETAILED DESCRIPTION OF EXEMPLARY EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

It will be understood that, although the terms first, second, etc. may be used herein to describe various elements, these elements should not be limited by these terms. These terms are only used to distinguish one element from another.

For example, a first element could be termed a second element, and, similarly, a second element could be termed a first element, without departing from the scope of the present invention.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Now, a diffraction element according to an exemplary embodiment and an optical module to which the diffractive element is applied will be described in detail with reference to the accompanying drawings, the same reference numerals may be used to denote the same corresponding components regardless of figure numbers, and the same descriptions thereof will be omitted.

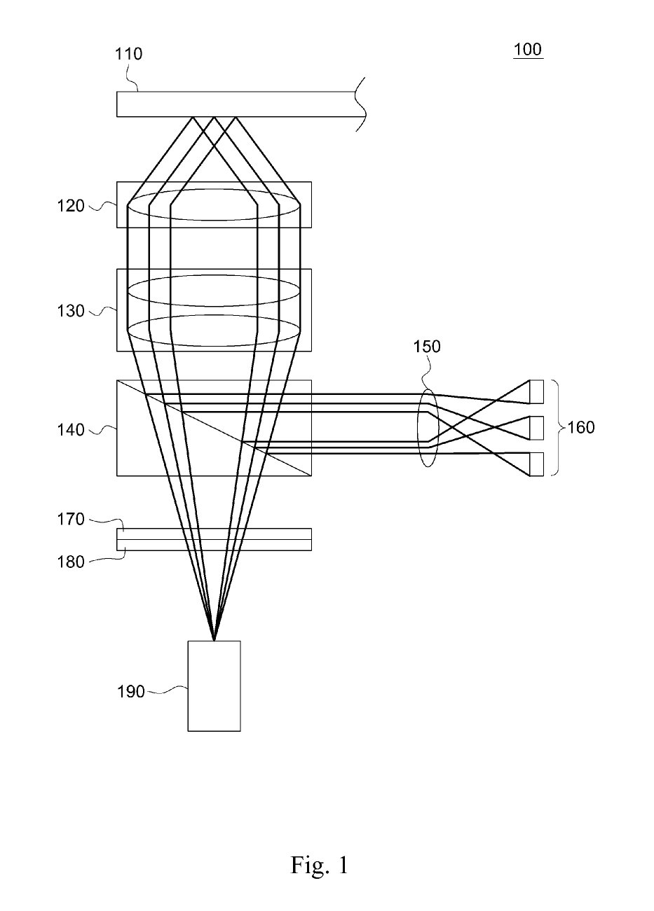

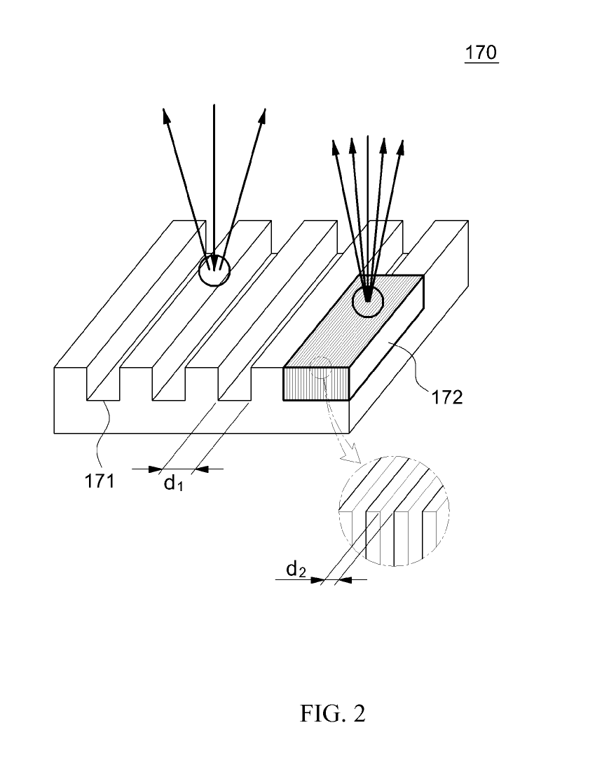

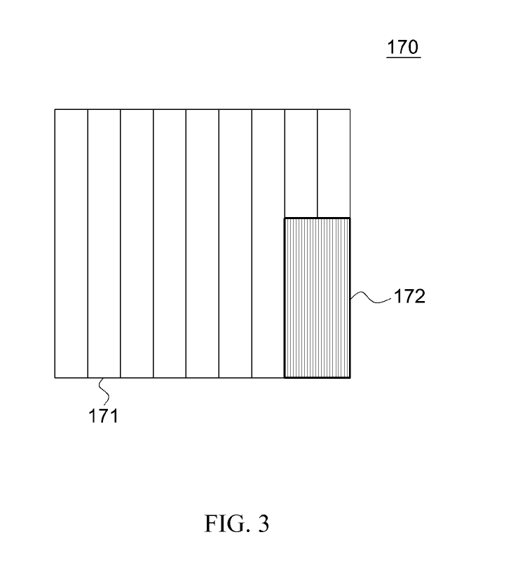

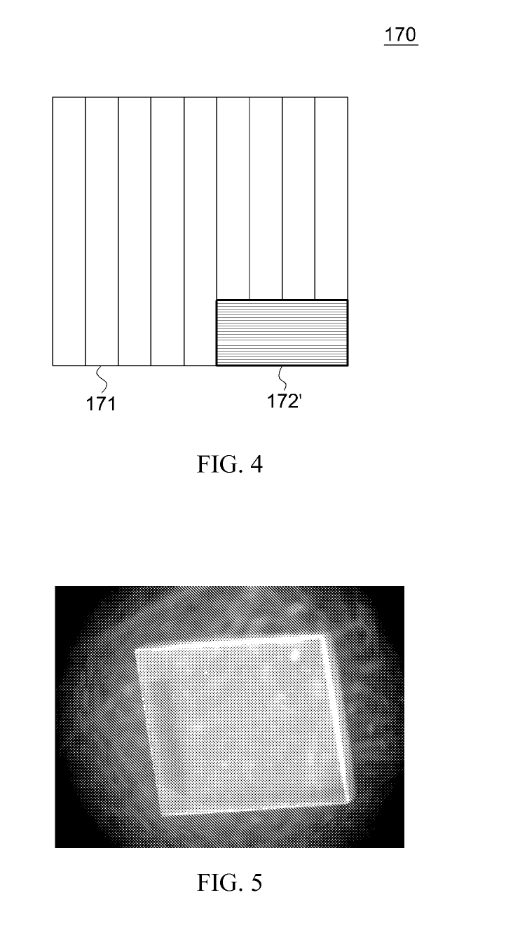

FIG. 1 illustrates the configuration of an optical pickup device to which a diffractive element is applied according to an exemplary embodiment of the present invention, FIG. 2 is a perspective view of a diffractive element according to a first exemplary embodiment of the present invention, FIG. 3 is a plan view of the diffractive element according to a first exemplary embodiment of the present invention, FIG. 4 is a plan view of a diffractive element according to a second exemplary embodiment of the present invention, and FIG. 5 illustrates a picture of an actually implemented diffractive element according to an exemplary embodiment of the present invention.

As illustrated in FIG. 1, an optical pickup device 100 to which a diffractive element according to the present exemplary embodiment is applied includes a laser diode 190 irradiating a laser beam, a diffractive element 170 dividing light intensity of the laser beam irradiated from the laser diode 190 at a predetermined ratio, a collimating lens 130 producing the laser beam transmitting through the diffractive element 170 as parallel rays of light, an object lens 120 focusing the parallel rays of light transmitting through the collimating lens 130 onto an optical disk 110, a beam splitting prism 140 transmitting or reflecting a reflected beam and an incident beam transmitting through the diffractive element 170 at a predetermined ratio whether or not data are recorded on the optical disk 110, a sensor lens 150 focusing the beams reflected through the beam splitting prism 140, and a photodetector 160 detecting data signals of the beams transmitting the sensor lens 150.

In order to focus laser light onto a track formed on an information recording surface of the optical disk 110 in the optical pickup device 100 and to rotate the optical disk, the focused beam of laser light should not be deviated from the track. Therefore, a 3-beam method in which laser light is divided into a main beam that is a zero-order diffraction light and two sub-beams that are positive and negative first-order diffraction lights is used, and here, the diffractive element 170 is used to divide the laser light into the main beam and the sub-beams. The diffractive element 170 is installed in an optical path of the laser light, and diffraction by which laser light is divided into a main beam and two sub-beams occurs in a diffraction region that is a characteristic structure.

As described above, the diffractive element 170 should be installed at an exact position as intended due to its diffraction characteristics, and the element 170 should be installed such that a longitudinal direction of a diffraction pattern faces an intended direction. Therefore, as illustrated in FIGS. 2 and 3, at a corner of the quadrilateral diffractive element 170, i.e., in a region that does not have an effect on a moving direction of laser light, an alignment mark pattern 172 for recognizing an alignment position is formed. In the present exemplary embodiment, the diffractive element 170 includes a main diffraction pattern 171 for creating diffraction characteristics, and an alignment mark pattern 172 for recognizing an alignment position having a different pitch from that of the main diffraction pattern 171. The diffractive element 170 is formed to a size of 1.5 mm×1.5 mm, and the alignment mark pattern 172 for recognizing an alignment position is implemented to a size of 0.3 mm×0.4 mm at the corner of the diffractive element 170 not to have an effect on the moving direction of laser light.

In the present exemplary embodiment, while it is described that the alignment mark pattern 172 is formed in the shape of a regular rectangle in a plan view, it is not limited thereto, but may be formed in a pattern having a predetermined curvature such as a circle or an oval, a polygonal pattern, an embossed pattern, or a lattice pattern. Also, it may be obvious to one of ordinary skill in the art that the patterns may be regularly or irregularly arranged.

In the present exemplary embodiment, it is exemplified that a pitch d2 of the alignment mark pattern 172 is formed smaller than a pitch d1 of the main diffraction pattern 171, but it is not limited thereto.

As illustrated in FIG. 3, the longitudinal direction of the alignment mark pattern 172 may be in the same direction as that of the main diffraction pattern 171 or may be formed to be perpendicular thereto as illustrated in FIG. 4.

As described above, the pitch d2 of the alignment mark pattern 172 is formed smaller than the pitch d1 of the main diffraction pattern 171, and as illustrated in FIG. 3, the alignment mark pattern 172 is recognized as being different from the main diffraction pattern 171 depending on a difference in light emitted in a specific direction. Therefore, when the pickup device 100 is fabricated based on the corner where the alignment mark pattern 172 is formed, alignment for installing the diffractive element 170 may be performed.

This is confirmed through the picture of FIG. 5, wherein the pitch d1 of the main diffraction pattern 171 is implemented to 20 μm, and the pitch d2 of the alignment mark pattern 172 is implemented to 4 μm. Specifically, when the pitch d1 of the main diffraction pattern 171 is 5 μm or greater to 30 μm or less, the pitch d2 of the alignment mark pattern 172 is formed to be 1 μm or greater to 6 μm or less. That is, a ratio of the pitch of the main diffraction pattern to that of the alignment mark pattern may be ⅛ or greater to ½ or less, and more preferably, may be ⅙ or greater to ¼ or less. It is difficult to fabricate the alignment mark pattern 172 less than 1 μm in terms of fabricating process, and the pattern exceeding 6 μm is not visible to the eyes in contrast to the main diffraction pattern 171.

As illustrated in FIG. 5, the alignment mark pattern 172 is clearly different from the main diffraction pattern 171 in terms of difference in intensity of emitted light, and the mark alignment pattern 172 enables top, bottom, left and right sides of the diffractive element 170 to be clear in the drawing. Also, as illustrated in FIG. 5, a plurality of patterns, a side of which is in a quadrangle shape, and the other side of which is a triangle shape, are provided to enable an alignment position to be confirmed and positions of the upper and lower sides (whether or not the pattern is turned upside down) to be confirmed as well.

In addition, the same effect of the alignment mark pattern 172 may be obtained depending on a difference in depth between the main diffraction pattern 171 and the alignment mark pattern 172. That is, the depth of the main diffraction pattern 171 and that of the alignment mark pattern 172 are differentiated, respectively, to have different diffraction characteristics, so that intensity of emitted light of the main diffraction pattern 171 may be different from that of the alignment mark pattern 172. Here, the main diffraction pattern 171 and the alignment mark pattern 172 may be formed to a depth of 0.1 μm or greater to 0.7 μm or less. When the depth is less than 0.1 μm, it facilitates transmission of light rather than diffraction, and when the depth exceeds 0.7 μm, it is difficult to fabricate the patterns.

In the present exemplary embodiment, the pitches and depths of the main diffraction pattern 171 and the alignment mark pattern 172 may be combined such that the alignment mark pattern 172 may be formed to have diffraction characteristics as a fiducial mark.

That is, even when only the pitch of the alignment mark pattern 172 is changed, the depth of the alignment mark pattern 172 is changed, or both the pitch and depth of the alignment mark pattern 172 are changed without changing the main diffraction pattern 171, the same effect in which the alignment mark pattern 172 is recognized as a fiducial mark as described above may be obtained.

As illustrated in FIG. 1, the diffractive element 170 may be combined with a polarizing filter 180 on its top or bottom surface to be treated as an optical module, and may be further combined with an optical element such as a wave plate (not shown).

As described above, at a corner of a diffractive element, i.e., in a region that does not interfere with movement of light, an alignment mark pattern for alignment recognition is formed, so that a position where the pattern is installed can be easily confirmed. Therefore, an optical pickup device such as a CD or DVD player can be fabricated speedily, and mass production thereof can be facilitated.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A diffractive element, comprising:
a plurality of diffraction patterns, wherein the diffraction patterns include a main diffraction pattern for creating diffraction characteristics, and an alignment mark pattern for recognizing an alignment position, the alignment mark pattern having a different pitch from the main diffraction pattern.

2. The diffractive element of claim 1, wherein the pitch d2 of the alignment mark pattern is formed smaller than the pitch d1 of the main diffraction pattern.

3. The diffractive element of claim 1, wherein a ratio of the pitch d2 of the alignment mark pattern to the pitch d1 of the main diffraction pattern is ⅛ or greater to ½ or less.

4. The diffractive element of claim 3, wherein the pitch of the main diffraction pattern is 5 μm or greater to about 30 μm or less, and the pitch of the alignment mark pattern is about 1 μm or greater to about 6 μm or less.

5. The diffractive element of claim 1, wherein the diffractive element has a quadrilateral shape in a plan view thereof, and the alignment mark pattern is formed at a corner of the quadrilateral.

6. The diffractive element of claim 1, wherein the depth of the main diffraction pattern is different from that of the alignment mark pattern.

7. The diffractive element of claim 6, wherein the depth of the alignment mark pattern is about 0.1 μm or greater to about 0.7 μm or less.

8. The diffractive element of claim 1, wherein the alignment mark pattern is formed of a plurality of patterns having different shapes.

9. The diffractive element of claim 1, wherein a longitudinal direction of the alignment mark pattern is in the same direction as a longitudinal direction of the main diffraction pattern.

10. The diffractive element of claim 1, wherein a longitudinal direction of the alignment mark pattern is perpendicular to a longitudinal direction of the main diffraction pattern.

11. An optical module, comprising:
a diffractive element comprising a plurality of diffraction patterns, wherein the diffraction patterns include a main diffraction pattern for creating diffraction characteristics, and an alignment mark pattern for recognizing an alignment position, the alignment mark pattern having a different pitch from the main diffraction pattern; and
at least one of a polarizing filter or a wave plate on a top or bottom surface of the diffractive element.
